(19) United States
(12) Patent Application Publication
(10) Pub. No.: US 2024/0332928 A1
(43) Pub. Date: Oct. 3, 2024

(54) BATTERY MODULE

(71) Applicant: Shenzhen CLOU Electronics CO., LTD, Shenzhen (CN)

(72) Inventors: Hongnan LIU, Shenzhen (CN); Lei WU, Shenzhen (CN); Guangli LI, Shenzhen (CN); Haozhe CHEN, Shenzhen (CN)

(73) Assignee: Shenzhen CLOU Electronics CO., LTD, Shenzhen (CN)

(21) Appl. No.: 18/618,085

(22) Filed: Mar. 27, 2024

(30) Foreign Application Priority Data
Mar. 31, 2023 (CN) 202310354973.4

(51) Int. Cl. H02G 3/04; H01B 7/00; H01M 50/528

(52) U.S. Cl. CPC H02G 3/0456; H01B 7/0045; H01M 50/528

(57) ABSTRACT

A battery module is disclosed, including an acquiring wire harness, a plurality of fixing members, and a plurality of locating rings. The plurality of fixing members are respectively provided at a plurality of overturning bends of the acquiring wire harness, and the fixing members are used to fix the acquiring wire harness at the overturning bends. The plurality of locating rings are arranged on the acquiring wire harness at intervals along a length direction of the acquiring wire harness. Applying the disclosure of the above embodiments, by providing locating rings on the acquiring wire harness to constrain the acquiring wire harness, can prevent battery cells from being scattered to affect the safety and aesthetics during transportation or operation.

### CROSS-REFERENCE TO RELATED APPLICATIONS

This U.S. application claims priority to Chinese patent application No. 202310354973.4 filed Mar. 31, 2023, the contents of which are incorporated herein by reference in their entirety.

### TECHNICAL FIELD

The present disclosure relates to the technical field of batteries, and in particular to a battery module.

### BACKGROUND

The storage of electrical energy has been a problem since the establishment of power systems. Nowadays, electrochemical energy storage is an important part of new power systems. Electrochemical energy storage is the process of storing electrical energy through a medium or device and releasing it when needed, which is an important means to solve the intermittency and instability of renewable energy sources and to improve the efficiency, safety and economy of conventional power systems and regional energy systems.

The battery module is a core unit of electrochemical energy storage, in which the voltage and temperature of battery cells are important parameters related to SOC calculation, life estimation, and thermal protection of the battery cells, and these parameters must be transmitted to a battery module management unit as input criteria for battery management. The battery module usually includes a plurality of battery cells which are easily scattered. In addition, the battery cells need to be bent at right angles in the battery module. Due to high bending stress of cables and limited wiring space in the battery module, it is difficult for the personnel to operate when bending the battery cells, and the battery cells are easy to reset after bending.

### SUMMARY

The present disclosure aims to solve at least one of the technical problems in the existing technology. For this purpose, the present disclosure provides a battery module which can facilitate wiring and ensure the regularity of battery cells.

A battery module according to an embodiment of the present disclosure includes an acquiring wire harness, a plurality of fixing members, and a plurality of locating rings. The plurality of fixing members are respectively provided at a plurality of overturning bends of the acquiring wire harness, and the fixing members are used to fix the acquiring wire harness at the overturning bends. The plurality of locating rings are arranged on the acquiring wire harness at intervals along a length direction of the acquiring wire harness.

A battery module according to an embodiment of the present disclosure has at least the following beneficial effects:

By providing locating rings on the acquiring wire harness to constrain the acquiring wire harness, the present disclosure of the above embodiment can prevent battery cells from being scattered to affect the safety and aesthetics during transportation or operation. Moreover, by providing the fixing members in the present disclosure, the stress at the overturning bends of the acquiring wire harness can be eliminated, thereby reducing the operating difficulty of the staff. The battery cells can be fixed at the overturning bends through the fixing members to maintain a stable state.

According to some embodiments of the present disclosure, each fixing member is provided with a male fixing member and a female fixing member, where the male fixing member and female fixing member are capable of being assembled up and down; a side of the male fixing member is provided with at least two first relief slots with a 90 degree angle between two adjacent first relief slots, and the female fixing member is provided with a second relief slot corresponding to each of the first relief slots; and after the male fixing member and the female fixing member are assembled, the first relief slots and the second relief slots form an overall relief slot for the acquiring wire harness to pass through.

According to some embodiments of the present disclosure, both the male fixing member and the female fixing member are in shape of cuboid or cube.

According to some embodiments of the present disclosure, both the male fixing member and the female fixing member are provided with a plurality of side walls with an arc transition between two adjacent side walls.

According to some embodiments of the present disclosure, four corners of each female fixing member are all provided with pin holes, and four corners of each male fixing member are provided with pins for inserting through the pin holes.

According to some embodiments of the present disclosure, the battery module further includes an insulating outer plate and a bottom of the locating ring is bonded to the insulating outer plate.

According to some embodiments of the present disclosure, the acquiring wire harness includes a first acquiring wire harness and a second acquiring wire harness, both overturning bends of the first acquiring wire harness and second acquiring wire harness are provided with the fixing members.

According to some embodiments of the present disclosure, both the first acquiring wire harness and the second acquiring wire harness are provided with a shielding layer externally.

According to some embodiments of the present disclosure, the acquiring wire harness is wired in parallel, and each battery cell of the acquiring wire harness is bonded with an insulating flame-retardant adhesive.

According to some embodiments of the present disclosure, the battery module further includes an integrated acquiring plate, and the integrated acquiring plate is welded to electrodes of the battery cell and used to acquire parameters of temperature and voltage.

Additional features and advantages of the present disclosure will be given, in part, from the description which follows, and in part will become apparent from the description, or may be learned by the practice of the present disclosure.

### BRIEF DESCRIPTION OF DRAWINGS

The present disclosure will be further described below in conjunction with the accompanying drawings and embodiments, in which

FIG. 1 is a first perspective view of a battery module according to an embodiment of the present disclosure;

FIG. 2 is a second perspective view of the battery module according to an embodiment of the present disclosure;

FIG. 3 is a third perspective view of the battery module according to an embodiment of the present disclosure;

Reference numerals for accompanying drawings:
101, first acquiring wire harness; 102, second acquiring wire harness; 103, fixing member; 104, locating ring; 105, male fixing member; 106, female fixing member; 107, first relief slot; 108, second relief slot; 109, pin hole; 110, pin; 111, integrated acquiring plate; 112, first acquiring wire harness connector; and 113, second acquiring wire harness connector.

### DETAILED DESCRIPTION

Embodiments of the present disclosure will be described in detail below, and examples of the embodiments are illustrated in the accompanying drawings. Throughout the same or similar reference numerals refer to the same or similar elements or elements with the same or similar functions. The embodiments described below with reference to the accompanying drawings are exemplary and serve only to explain the present disclosure, and should not be understood as limitations of the present disclosure.

In the description of the present disclosure, it should be understood that, referring to orientation description, the instructed orientation or positional relationship (for example, upper, lower, etc.) based on the orientation or positional relationships shown in the accompanying drawings is merely for ease of describing the present disclosure and simplifying the description, rather than indicating or implying that the device or element referred to must have a specific orientation and be constructed and operated in a specific orientation. Therefore, the orientation or positional relationships shown in the accompanying drawings cannot be construed as a limitation of the present disclosure.

In the description of the present disclosure, “several” refers to “one or more”, “a plurality of” refers to “two or more, “greater than, less than, over, etc.” are understood to exclude this number, and “above, below, within, etc.” are understood to include this number. If described, “first” or “second” are only for the purpose of distinguishing technical features, and cannot be understood as indicating or implying relative importance or implicitly indicating the number of indicated technical features or implicitly indicating the precedence relationship of indicated technical features.

In the description of the present disclosure, unless explicitly defined otherwise, words such as providing, mounting or connecting should be understood in a broad sense. Those skilled in the art can reasonably determine the specific meaning of the above words in the present disclosure in conjunction with the specific content of the technical solution.

In addition, the technical solutions between the embodiments of the present disclosure can be combined with each other, but it must be based on what can be achieved by a person of ordinary skilled in the art. When the combination of technical solutions is contradictory or cannot be implemented, it should be considered that such a combination of technical solutions is nonexistent and is not within the scope of protection required by the present disclosure.

Referring to FIGS. 1 to 3, a battery module according to an embodiment of the present disclosure includes an acquiring wire harness, a plurality of fixing members 103, and a plurality of locating rings 104. The plurality of fixing members 103 are respectively provided at a plurality of overturning bends of the acquiring wire harness, and the fixing members 103 are used to fix the acquiring wire harness at the overturning bends. The plurality of locating rings 104 are arranged on the acquiring wire harness at intervals along a length direction of the acquiring wire harness.

Applying the disclosure of the above embodiment, by providing locating rings 104 on the acquiring wire harness to constrain the acquiring wire harness, can prevent battery cells from being scattered to affect the safety and aesthetics during transportation or operation. By providing the fixing members 103, the stress at the overturning bends of the acquiring wire harness can be eliminated, thereby reducing the operating difficulty of the staff. The battery cells can be fixed at the overturning bends through the fixing members 103 to maintain a stable state. The fixing members 103 are commonly made of plastic material, or other flame-retardant, insulating, and temperature-resistant materials.

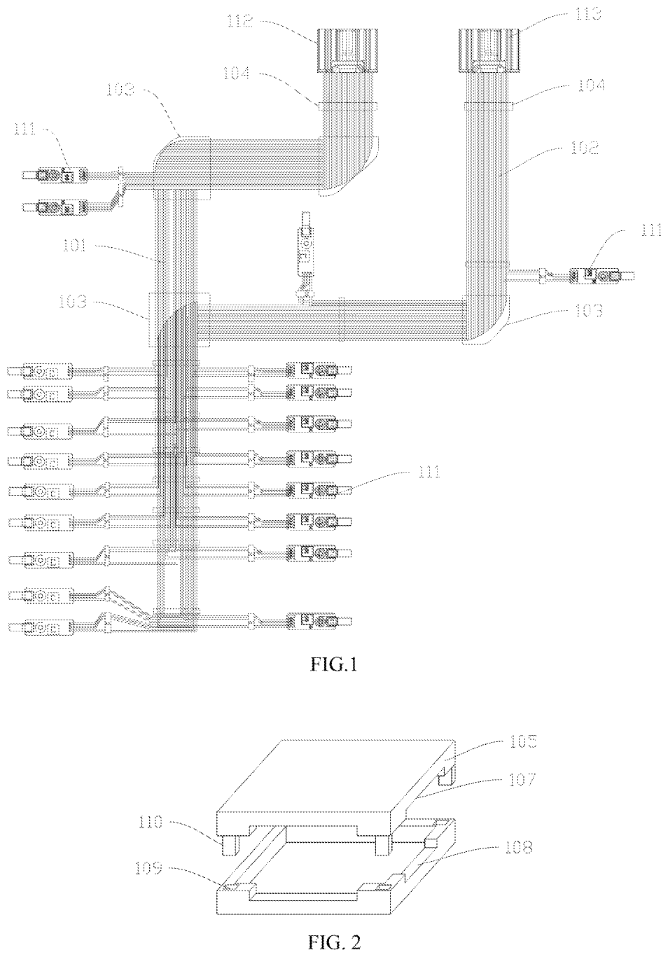

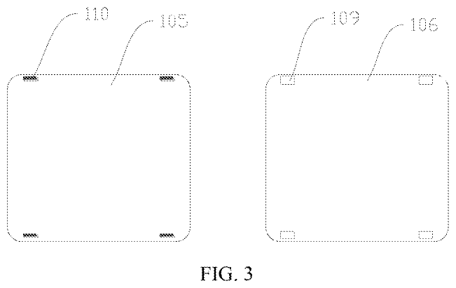

Referring to FIGS. 2 and 3, it can be understood that each fixing member 103 is provided with a male fixing member 105 and a female fixing member 106, which are capable of being assembled up and down; a side of the male fixing member 105 is provided with at least two first relief slots 107 with a 90 degree angle between two adjacent first relief slots 107, and the female fixing member 106 is provided with a second relief slot 108 corresponding to each of the first relief slots 107; and after the male fixing member 105 and the female fixing member 106 are assembled, the first relief slots 107 and the second relief slots 108 form an overall relief slot for the acquiring wire harness to pass through. It can be understood that the overall relief slot can also be provided on the male fixing member 105 or the female fixing member 106 separately, that is, the male fixing member 105 or the female fixing member 106 is of a cabinet structure with a top surface or bottom surface having an opening, and the overall relief slot is provided on the side of the male fixing member 105 or the female fixing member 106. Accordingly, the female fixing member 106 or the male fixing member 105 is of a plate-like structure capable of closing the opening.

It can be understood that edges of the first relief slots 107 and the second relief slots 108 are all provided with arc transitions, so as to prevent sharp right angles from damaging the acquiring wire harness.

Referring to FIGS. 2 and 3, it can be understood that the male fixing member 105 and the female fixing member 106 are in shape of cuboid or cube.

It can be understood that the male fixing member 105 and the female fixing member 106 are provided with a plurality of side walls with an arc transition between two adjacent side walls. The arrangement of arc transitions can prevent sharp right angles from scratching personnel.

Referring to FIGS. 2 and 3, it can be understood that four corners of each female fixing member 106 are all provided with pin holes 109, and four corners of each male fixing member 105 are provided with pins 110 that match the pin holes 109.

It can be understood that the four pin holes 109 are distributed in a matrix, and the production of the pin holes 109 and the pins 110 is more convenient.

It can be understood that the battery module further includes an insulating outer plate to which a bottom of the locating ring 104 is bonded.

Referring to FIG. 1, it can be understood that the acquiring wire harness includes a first acquiring wire harness 101 and a second acquiring wire harness 102, both overturning bends of the first acquiring wire harness and second acquiring wire harness are provided with the fixing members 103.

In order to prevent interference and distortion when acquiring electrical signals of voltage and temperature, both the first acquiring wire harness 101 and the second acquiring wire harness 102 each provided with a shielding layer externally.

It can be understood that the acquiring wire harness is wired in parallel, and each battery cell of the acquiring wire harness is bonded with an insulating flame-retardant adhesive.

The battery module, during the process of use, needs to acquire electrical signals such as voltage and temperature of each battery cell, so as to facilitate the control module to perform equalization operations on each battery cell, thereby ensuring battery module outputs and stable voltage and current. In actual operation, wires are usually welded on poles of each battery cell, and the other ends of the wires are connected to acquiring joints to realize electrical signal acquisition of the battery cells. The acquiring joints are tightened with bolts. On this basis, the production workshop must carry out operations such as positioning, applying torque, and drawing torque marking lines, resulting in more man-hours and the consistency of personnel operations being difficult to control, and having a risk of loosening when the battery cells heat up or vibrate during the operation. Referring to FIG. 1, in this embodiment, the battery module further includes an integrated acquiring plate 111, which is welded to electrodes of the battery cells and used to acquire the parameters of temperature and voltage, which can reduce man-hours and can also prevent the problem of difficult operation control and abnormal loose occurred by applying the bolt fastening mode.

Referring to FIGS. 1 to 3 below, this embodiment will be set forth in detail by taking 20 battery cells to form a battery module as an example.

The acquiring wire harness of 10 battery cells is the first acquiring wire harness 101, and the other 10 battery cells are formed as the second acquiring wire harness 102. Both the first acquiring wire harness 101 and the second acquiring wire harness 102 are provided with a shielding layer externally, and the shielding layers are single-ended grounded through a battery module management unit. The first acquiring wire harness 101 is connected to a first acquiring wire harness connector 112, and the second acquiring wire harness 102 is connected to a second acquiring wire harness connector 113. Both the first acquiring wire harness 101 and the second acquiring wire harness 102 are wired in parallel, and each battery cell is bonded with an insulating flame-retardant adhesive which has temperature resistance. The 90-degree overturning bends of the first acquiring wire harness 101 and the second acquiring wire harness 102 are fixed by the fixing members 103. The fixing members 103 are commonly made of plastic material, or other flame-retardant, insulating, and temperature-resistant materials. The appearance and size of the fixing members 103 can be customized according to actual situations of the acquiring wire harness, such as being in shape of cuboid or cube, or in other special shapes. Taking the shape of a cube as an example, each fixing member 103 is provided with a male fixing member 105 and a female fixing member 106. Four corners of each female fixing member 106 are all provided with pin holes 109, and four corners of each male fixing member 105 are provided with pins 110 that match the pin holes 109. A side of the male fixing member 105 is provided with at least two first relief slots 107 with a 90-degree angle between two adjacent first relief slots 107, and the female fixing member 106 is provided with a second relief slot 108 corresponding to each of the first relief slots 107. During the process of actual use, the female fixing members 106 are first placed below the overturning bends of the acquiring wire harness, and then the pins 110 of the male fixing members 105 are aligned with the pin holes 109 of the female fixing members 106 from the top of the acquiring wire harness and pressed into the pin holes 109. The spatial positions of the pins 110 match those of the pin holes 109. The first relief slots 107 and the second relief slots 108 form a complete overall relief slot. The acquiring wire harness can be directly turned 90 degrees in the fixing members 103 to exit or enter through the overall relief slot of the fixing members 103, ensuring that the overall effect is beautiful and tight. The battery module further includes an integrated acquiring plate 111, which is welded to electrodes of the battery cells and used to acquire parameters of temperature and voltage.

In the description of the present specification, description of reference terms such as “one embodiment”, “some embodiments”, “illustrative embodiments”, “examples”, “specific examples”, or “some examples” implies that specific features, structures, materials or characteristics described in conjunction with the embodiments or examples are included in at least one embodiment or example of the present disclosure. In the present specification, the schematic expression of the above terms does not necessarily refer to the same embodiment or example. Furthermore, the specific features, structures, materials or characteristics described can be combined in a suitable manner in any one or more embodiments or examples.

Although embodiments of the present disclosure have been shown and described, those of ordinary skilled in the art will understand that various changes, modifications, substitutions and variations can be made to these embodiments without departing from the principles and purposes of the present disclosure, and the scope of the present disclosure is defined by the claims and the equivalents thereof.

What is claimed is:

1. A battery module, comprising:
an acquiring wire harness;
a plurality of fixing members respectively provided at a plurality of overturning bends of the acquiring wire harness, wherein the fixing members are used to fix the acquiring wire harness at the overturning bends; and
a plurality of locating rings arranged on the acquiring wire harness at intervals along a length direction of the acquiring wire harness.

2. The battery module according to claim 1, wherein each fixing member is provided with a male fixing member and a female fixing member, the male fixing member and the female fixing member are capable of being assembled up and down; a side of the male fixing member is provided with at least two first relief slots with a 90 degree angle between two adjacent first relief slots, and the female fixing member is provided with a second relief slot corresponding to each of the first relief slots; and after the male fixing member and the female fixing member are assembled, the first relief slots and the second relief slots form an overall relief slot for the acquiring wire harness to pass through.

3. The battery module according to claim 2, wherein both the male fixing member and the female fixing member are in shape of cuboid or cube.

4. The battery module according to claim 3, wherein both the male fixing member and the female fixing member are provided with a plurality of side walls with an arc transition between two adjacent side walls.

5. The battery module according to claim 3, wherein four corners of each female fixing member are all provided with pin holes, and four corners of each male fixing member are provided with pins for inserting through the pin holes.

6. The battery module according to claim 1, wherein the battery module further comprises an insulating outer plate, and a bottom of the locating ring is bonded to the insulating outer plate.

7. The battery module according to claim 1, wherein the acquiring wire harness comprises a first acquiring wire harness and a second acquiring wire harness, both overturning bends of the first acquiring wire harness and second acquiring wire harness are provided with the fixing members.

8. The battery module according to claim 7, wherein both the first acquiring wire harness and the second acquiring wire harness are provided with a shielding layer externally.

9. The battery module according to claim 1, wherein the acquiring wire harness is parallel in parallel, and each battery cell of the acquiring wire harness is bonded with an insulating flame-retardant adhesive.

10. The battery module according to claim 9, wherein the battery module further comprises an integrated acquiring plate, and the integrated acquiring plate is welded to electrodes of the battery cell and used to acquire parameters of temperature and voltage.
